(19) United States
(12) Patent Application Publication
(10) Pub. No.: US 2008/0278454 A1
(43) Pub. Date: Nov. 13, 2008

(54) METHOD FOR SETTING TOUCH SENSITIVITY IN PORTABLE TERMINAL

(75) Inventors: Hae-Jeong LEE, Gumi-si (KR); Hee-Seok JUNG, Gumi-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/117,258

(22) Filed: May 8, 2008

(30) Foreign Application Priority Data
May 8, 2007 (KR) 2007-0044597
Aug. 22, 2007 (KR) 2007-0084432

(51) Int. Cl. G06F 3/041

(52) U.S. Cl. 345/173

(57) ABSTRACT

An apparatus and method for setting touch sensitivity in a portable terminal are provided. The method includes activating a touch screen function of a touch pad when a display unit is activated in a standby mode of the portable terminal, displaying a menu screen for conducting a current mode on the display unit, switching the menu screen to a touch sensitivity mode and displaying touch sensitivity levels when the touch sensitivity mode is selected as the current mode, setting sensitivity of the touch pad according to one of the touch sensitivity levels selected by the user and storing the set sensitivity of the touch pad. Advantageously, the user can conveniently use the touch pad, the sensitivity of which is set as desired by the user.

### PRIORITY

This application claims the benefit under 35 U.S.C. §119(a) of a Korean patent application filed in the Korean Industrial Property Office on May 8, 2007 and assigned Serial No. 2007-44597 and of a Korean patent application filed in the Korean Industrial Property Office on Aug. 22, 2007 and assigned Serial No. 2007-84432, the entire disclosures of both of which are hereby incorporated by reference.

### BACKGROUND OF THE INVENTION

1. Field of the Invention

The present invention relates to a portable terminal. More particularly, the present invention relates to a method for setting the touch sensitivity of a touch pad.

2. Description of the Related Art

Typically, the term “touch screen” refers to a kind of display device that also functions as an input device. Recently, touch screens have been applied to various terminals, such as mobile phones, smart phones, cash dispensers, palm PCs, Personal Digital Assistants (PDAs), or the like. Examples of mobile terminals with a touch screen may include electronic diaries, mobile phones, PDAs, or the like.

As stated above, a touch screen may function as both a display device and an input device. When using a touch screen as an input device, a user may input a command or an information item by simply touching the screen. More specifically, the touch screen provides an interface that allows the user to provide input simply by touching one or more icons displayed on the screen. Moreover, the input may be easily made with the user's finger, a stylus pen or the like. The touch screen also functions as a display device which is a benefit due to the recent trend in mobile terminals to reduce both their size and weight. That is, a touch screen assists in miniaturizing and lightening a portable terminal because it not only provides a display unit, but also provides a user interface without needing to employ a separate keyboard.

Such a portable terminal also contains a transceiver unit, so that the terminal is capable of implementing a telephone function. A conventional user interface related to a call on a portable terminal has a form as shown in FIG. 1.

FIG. 1 shows a configuration of a portable terminal with a conventional touch screen.

As shown in FIG. 1, if the portable terminal enters a call-related mode, a user interface window is displayed on the screen. At this time, a series of number keys for dialing, and several call-related function keys, such as a call key, a cancel key, an end key, etc., are displayed on a display unit 110 as a touch screen 120.

In addition to the display unit 110 containing the touch screen 120, such a portable terminal is provided with a speaker 100 and a microphone 140, and one or more hardware buttons 130 may be occasionally provided in the portable terminal.

When it is desired to talk using the portable terminal, a user touches one or more corresponding icons provided on the touch screen 120 of the display unit 110 with a stylus or a finger so as to enter a phone number or execute the call key, thereby attempting to dial. Through this dialing process, the user may establish a call with a counterpart user and is thus capable of talking over the portable terminal.

The illustrated conventional touch screen uses an input device operated by touch. With this type of device, an input operation is implemented by sensing a reference pressure or a thermal effect rather than by pressing a button. However, due to differences in sensitivity level depending on, for example, the dielectric constant of the user or the pressure of the touch on the screen, input signals from the touch screen desired by the user may not be properly recognized. As a result, the desired input may not be received. Accordingly, there is an inconvenience in that the user may need to repetitively press on the touch screen to achieve the desired input.

### SUMMARY OF THE INVENTION

An aspect of the present invention is to address at least the above-mentioned problems and/or disadvantages and to provide at least the advantages described below. Accordingly, an aspect of the present invention is to provide a portable terminal and a method for setting the touch sensitivity of touch pads to a sensitivity level desired by a user, so that the user can smoothly use the touch pads, the touch sensitivity of which is optimized.

According to an aspect of the present invention, a method for setting touch sensitivity in a portable terminal is provided. The method includes activating a touch screen function of a touch pad when a display unit is activated in a standby mode of the portable terminal, displaying a menu screen for conducting a current mode on the display unit, switching the menu screen to a touch sensitivity mode and displaying touch sensitivity levels when the touch sensitivity mode is selected as the current mode, setting sensitivity of the touch pad according to one of the touch sensitivity levels selected by the user and storing the set sensitivity of the touch pad.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 illustrates a configuration of a portable terminal with a conventional touch screen;

FIG. 2 illustrates an internal configuration of a portable terminal according to an exemplary embodiment of the present invention;

FIG. 3 illustrates a flowchart of a method for setting the touch pad sensitivity of a portable terminal according to an exemplary embodiment of the present invention;

FIGS. 4A and 4B illustrate the method of FIG. 3;

FIGS. 5A and 5B illustrate first menu screens of a portable terminal according to an exemplary embodiment of the present invention; and

FIG. 6 illustrates second menu screens of a portable terminal according to an exemplary embodiment of the present invention.

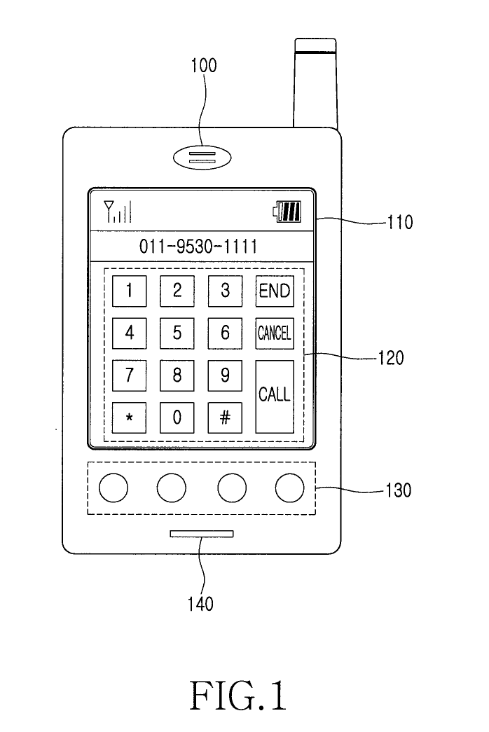

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

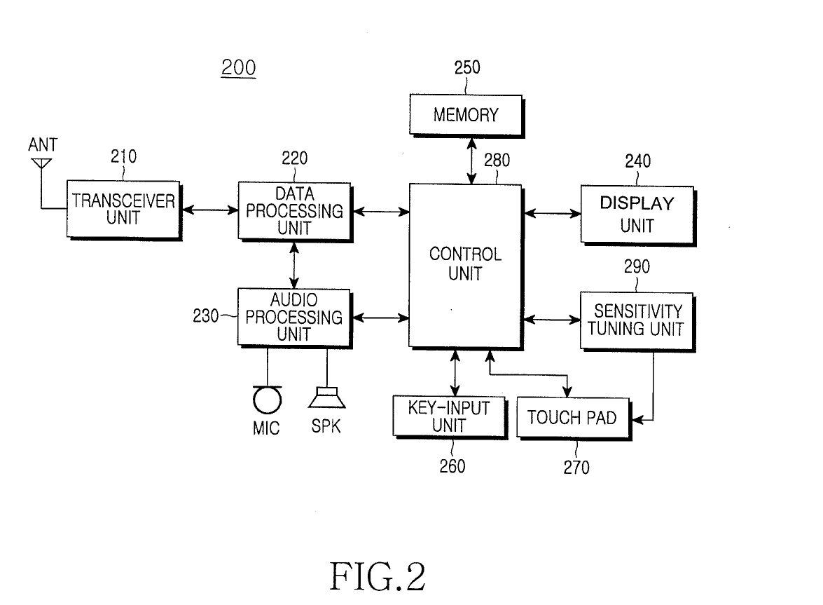

FIG. 2 illustrates an internal configuration of a portable terminal according to an exemplary embodiment of the present invention.

As illustrated in FIG. 2, the portable terminal 200 according to an exemplary embodiment of the present invention includes a wireless transceiver unit 210, a data processing unit 220, an audio processing unit 230, a display unit 240, a memory 250, a key-input unit 260, one or more touch pads 270, a control unit 280, and a sensitivity tuning unit 290.

The wireless transceiver unit 210 performs the wireless communication function of the portable terminal 200. The wireless transceiver unit 210 includes an RF transmitter for performing upward frequency conversion and amplification of signals being transmitted, and an RF receiver for performing low-noise amplification and downward frequency conversion of signals that are received.

The data processing unit 220 includes a transmitter for encoding and modulating signals being transmitted from the wireless transceiver 210, and a receiver for demodulating and decoding signals that are received. That is, the data processing unit 220 may consist of a MODEM and a CODEC. Here, the CODEC consists of a data CODEC for processing packet data or the like, and an audio CODEC for processing an audio signal, such as sound, wherein these CODECs may be separately provided or included in the control unit 280.

The audio processing unit 230 serves to reproduce received audio signals output from the audio CODEC of the data processing unit 220, or serves to transmit audio signals generated from the microphone to the audio CODEC of the data processing unit 220.

The display unit 240 may include a Liquid Crystal Display (LCD), which outputs various indication data generated in the portable terminal. At this time, if the LCD is implemented as a touch screen type, the display unit 240 may operate as an input unit.

The memory 250 may include a program memory and a data memory. The program memory may store programs for controlling ordinary operations of the portable terminal 200, and programs for controlling the sensitivity tuning unit 290 according to an exemplary embodiment of the present invention. In addition, the data memory serves to temporarily store data generated while conducting the programs.

The key-input unit 260 may include function keys for setting various functions of the portable terminal 200, and a plurality of input keys, wherein the user selects a specific input key so as to input desired information. The information input by keys pressed by the user is converted into an appropriate signal, for example a voltage signal and provided to the control unit 280.

The touch pads 270 are adapted to be touched by the user for inputting information according to an exemplary embodiment of the present invention. If there is an input made by a user's touch, the touch pads 270 output the inputted signals to the control unit 280. In addition, the touch pads 270 may be implemented by a touch screen included in the display unit 240, wherein the touch screen senses and converts the user's touch into coordinates, thereby producing touch key data. Furthermore, the touch input by a user on the touch pad 270 may include a touch by a user's finger, a contact made by a pen or stylus under control of the user and the like.

The touch pads 270 are key pads, each of which employs a touch sensor. An inputting operation using the touch screen is executed by determining coordinates, pressure or the like at an input point of the touch, whereas an inputting operation using the touch pads 270 is substantially the same as a key-inputting operation.

The control unit 280 performs a function for controlling the entire operation of the portable terminal 200. The control unit 280 also controls a special purpose program for setting the sensitivity of a touch pad 270. The special purpose program sets the sensitivity level of the touch pad 270 so as to ensure execution of a function corresponding to an input on the touch pad 270 when the input is received. The special purpose program may be installed in the control unit 280 and may be executed by the user. Of course, the special purpose program may be stored in the memory 250 and may be executed automatically.

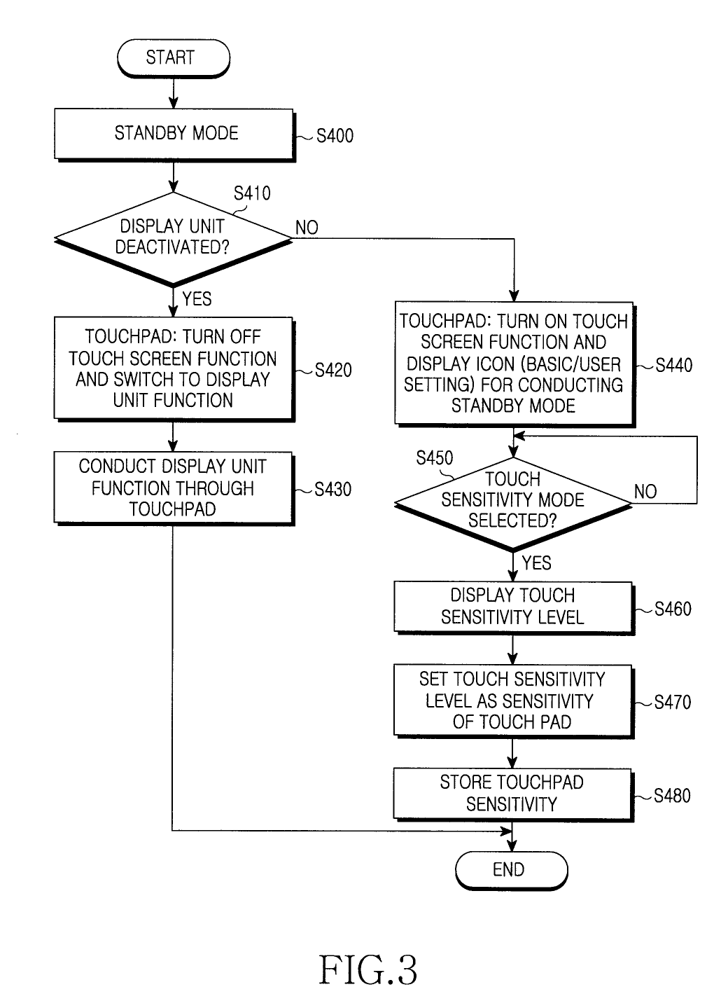

As will be explained in more detail with reference to FIGS. 3-6, the special purpose program may be presented on the display unit as an icon or a menu provided for setting the sensitivity level of the touch pads 270. The presented icon or menu may be selected by the user so as to perform the corresponding operation. At this time, the sensitivity of the touch pads 270 may correspond to an originally preset level or may be set by the user so as to ensure execution of the operations corresponding to the touch pads 270 when a touch is received.

The control unit 280 controls relevant components so that the sensitivity level of the touch pad 270 displayed on the display unit 240 is selected by the user and is set as the sensitivity of the touch pad 270. The sensitivity of the touch pad 270 set in this manner is then stored in the memory 250.

In addition, the sensitivity tuning unit 290 tunes the reference level according to the level of the touch pad 270, which results from the touch input from the user, under the control of the control unit 280.

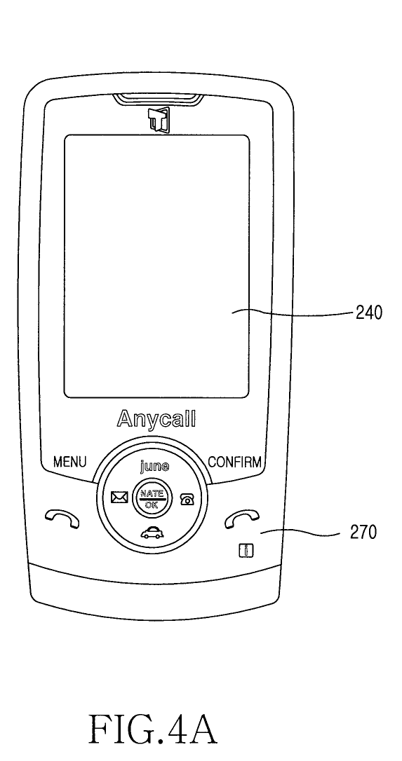

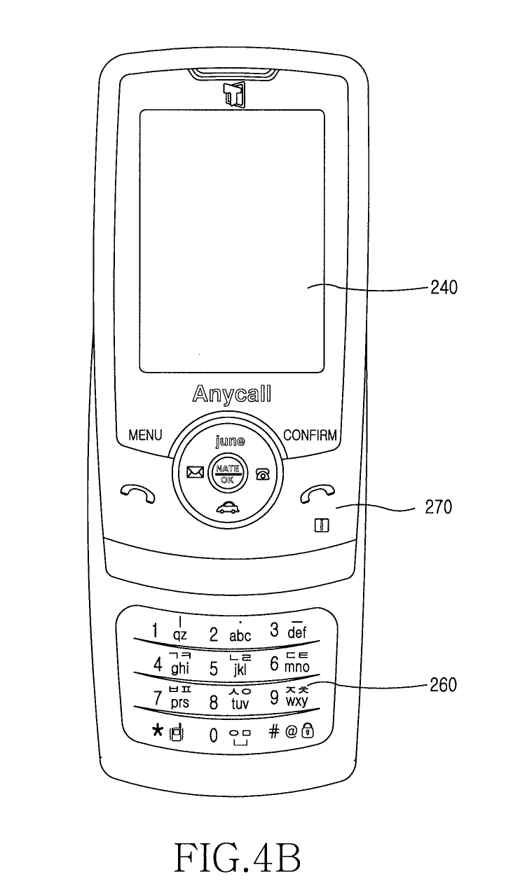

FIG. 3 illustrates a flowchart of a method for setting the touch pad sensitivity of a portable terminal according to an exemplary embodiment of the present invention, and FIGS. 4A and 4B illustrate the method of FIG. 3.

Referring to FIG. 3, the control unit 280 monitors the portable terminal 200, which is in a standby mode, in step S400. When the slide of the portable terminal 200 is moved down to deactivate the display unit 240 in step S410, as shown in FIG. 4A, the control unit 280 deactivates the touch screen function of the touch pad 270 and causes is to switch to the display unit 240 function in step S420.

After the touch pad 270 switches to the display unit 240 function, the control unit 280 controls the touch screen unit to conduct the function of a normal sub-display unit in step S430.

Particularly, the control unit 280 controls the touch pad 270, which has switched to the display unit 240 function, to display basic icons that are displayed in the standby mode of the portable terminal 200 or setup icons (e.g. morning call, alarm, etc.), as well as an incoming call or message.

When the slide of the portable terminal 200 is moved up to activate the display unit 240, as shown in FIG. 4B, the control unit 280 activates the touch screen function of the touch pad 270, and controls the display unit 240 to display a menu screen to conduct a corresponding function in the standby mode in step S440.

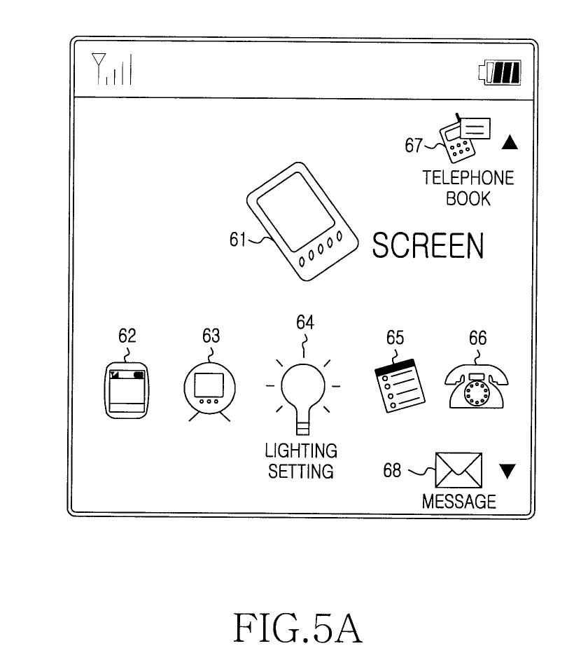

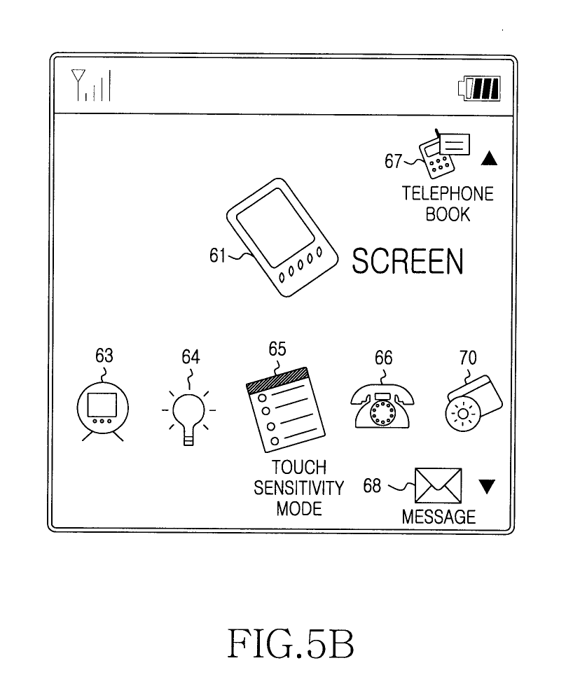

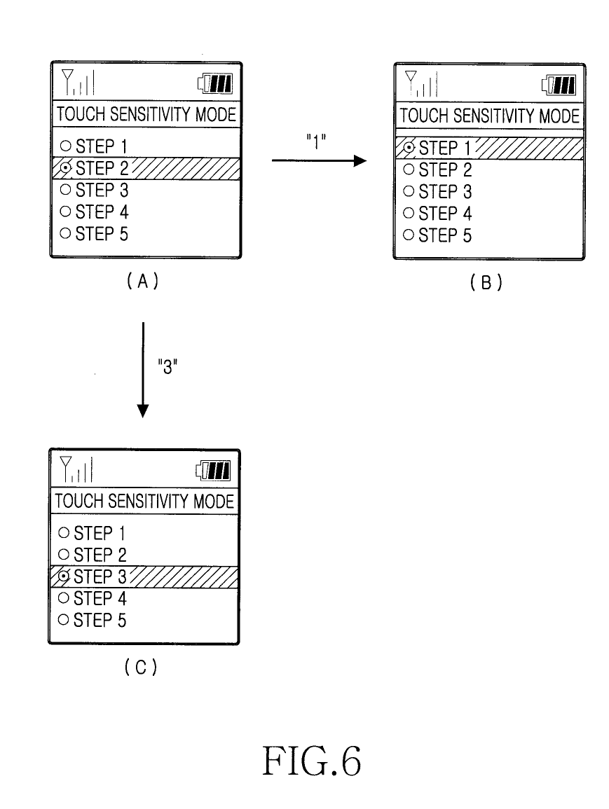

FIGS. 5A and 5B illustrate first menu screens of a portable terminal according to an exemplary embodiment of the present invention, and FIG. 6 illustrates second menu screens of a portable terminal according to an exemplary embodiment of the present invention.

For example, when the user enters the menu mode (by using a menu key, etc.) from the standby mode, as illustrated in FIG. 5A, the icon 61 of the upper menu ‘screen’, which has been used by the user lately, is displayed together with icons 62-66 corresponding to its lower menus (screen during normal time, background screen selection, lighting setup, touch sensitivity mode, and dial design) under the control of the control unit 280.

The ‘telephone number’ and ‘message’ icons 67 and 68 correspond to menus preceding and following the upper menu ‘screen’ 61, and these three menus are sister menus.

The lighting setup icon 64 is positioned at the center of the five icons and is enlarged (or highlighted). The underlying title ‘lighting setting’ indicates that the corresponding icon has been selected.

Meanwhile, if the control unit 280 confirms that the menu has been selected by the user, the control unit 280 controls the display unit 240 to display a specific mode, which has been selected by the user, so that the mode can be set up. If it is confirmed that the menu has not been selected by the user, the display unit 240 displays a default mode under the control of the control unit 280.

When the user selects key input “6” from the screen shown in FIG. 5A, the screen changes and displays the next item, i.e. “touch sensitivity mode”, as shown in FIG. 5B. In this case, the key input “6” acts as the right direction key. A comparison between the screens shown in FIGS. 5A and 5B reveals that, among the lower menus, the leftmost ‘screen during normal time’ 62 has disappeared, while a ‘screen brightness’ icon 70 has newly appeared at the rightmost side.

In addition, a ‘touch sensitivity mode’ icon 65 is positioned at the center and is enlarged (or highlighted), and the title “touch sensitivity mode” is displayed below the corresponding icon.

When the touch sensitivity mode is selected by means of the icons of the touch pad 270 or the keys of the key input unit 260 in step S450, the control unit 280 detects the selection, switches the portable terminal into the touch sensitivity mode, and controls the display unit 240 to display touch sensitivity levels for conducting the corresponding function in step S460.

More particularly, when the ‘touch sensitivity mode’ is selected, touch sensitivity levels (steps 1-5) are shown on the lower menu screen as shown in FIG. 6(A). Currently, the highlight is positioned at the item ‘step 2’.

When the user touches the key button “1” on the screen shown in FIG. 6(A), the position of the highlight is changed as shown in FIG. 6(B). Particularly, the position of the highlight is moved to the item ‘step 1’, which precedes the item ‘step 2’.

When the user touches the key button “3” on the screen shown in FIG. 6(A), the position of the highlight is changed as shown in FIG. 6(C). Particularly, the position of the highlight is moved to the item ‘step 3’, which follows the item ‘step 2’.

Then, the sensitivity of the touch pad 270 is set according to one of the displayed touch sensitivity levels (steps 1-5), which has been selected by the user, under the control of the control unit 280 in step S470. The sensitivity of the touch pad 270 set in this manner is then stored in the memory 250 in step S480. As such, the user can conveniently use the touch pad 270, the sensitivity of which has been set as desired by the user.

As described above, the present invention is advantageous in that the user can conveniently use the touch pad, the sensitivity of which is set as desired by the user.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for setting touch sensitivity in a portable terminal, the method comprising:
activating a touch screen function of a touch pad when a display unit is activated in a standby mode of the portable terminal;
displaying a menu screen for conducting a current mode on the display unit;
switching the menu screen to a touch sensitivity mode and displaying touch sensitivity levels when the touch sensitivity mode is selected as the current mode;
setting sensitivity of the touch pad according to one of the touch sensitivity levels selected by the user; and
storing the set sensitivity of the touch pad.

2. The method as claimed in claim 1, further comprising:
deactivating the touch screen function of the touch pad; and
switching to a display unit function when the display unit is deactivated in the standby mode of the portable terminal.

3. The method as claimed in claim 1, further comprising switching the menu screen to a specific mode so that the specific mode is displayed for setup when the specific mode is selected as the current mode.

4. The method as claimed in claim 1, wherein the touch sensitivity levels comprise respective steps.

5. A method for setting touch sensitivity in a portable terminal, the method comprising:
activating a touch screen function of a touch pad;
activating a menu screen for selecting a touch sensitivity mode;
displaying a plurality of touch sensitivity levels;
selecting one of the plurality of touch sensitivity levels;
setting a sensitivity level of the touch pad according to the selected touch sensitivity level; and
storing the set sensitivity of the touch pad.

6. A portable terminal having an adjustable touch sensitivity, comprising:
a touch pad; and
a controller, wherein the controller activates a touch screen function of the touch pad, activates a menu screen for selecting a touch sensitivity mode, displays a plurality of touch sensitivity levels on the touch pad, sets a sensitivity level of the touch pad according to a selected touch sensitivity level and stores the set sensitivity of the touch pad.
